(19) United States
(12) Patent Application Publication
(10) Pub. No.: US 2019/0351741 A1
(43) Pub. Date: Nov. 21, 2019

(54) REMOTE CONTROLLED AUTOMOBILE HEATER SYSTEM AND METHOD

(71) Applicant: Kouakou Joseph Dongo, Edmonton (CA)

(72) Inventor: Kouakou Joseph Dongo, Edmonton (CA)

(21) Appl. No.: 15/983,042

(22) Filed: May 17, 2018

(51) Int. Cl. B60H 1/22; B60H 1/00

(52) U.S. Cl. CPC B60H 1/2218; B60H 1/00657; B60H 2001/2293; B60H 1/00985; B60H 1/2225

(57) ABSTRACT

A remote-controlled automobile heater system includes a housing having a magnet disposed on the top-side that is able to secure the remote-controlled automobile heater system to the interior of the cab of an automobile. The housing includes a heating element and a mechanical fan that blows air across the heating element to create convective heat that disperses within the cab of the automobile. The remote-controlled automobile heater system further includes a transmitter capable of activating the heating element and the mechanical fan from a distance. The remote-controlled automobile heater system is useful for attaching to the interior cab of an automobile for pre-heating the automobile cab before driving.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of heaters of existing art and more specifically relates to a space heater.

### RELATED ART

Heaters are used during winter months and cold conditions. Entire home heating devices are integrated into virtually every modern home. Generally, a central furnace is designated to provide heat to an entire home. The furnace works by flowing heated air through ducts that branch off to reach individual rooms. The rooms have ported outlets that include diffusers to evenly disperse the air. Similarly, automobiles utilize forced air heating systems to heat the passenger compartment of an automobile. Fluid is heated and flows past a heat exchanger where air is blown into the passenger compartment. The heating of the fluid relies on the automobile to be running and the burning of fossil fuels.

An alternative method of heating a small room in a home is to employ a space heater. A space heater is a device designed to only produce enough heat to modify the temperature of a small volume of air. The space heaters are typically powered by either electricity or a combustible fuel such as natural gas or oil. Space heaters are inexpensive and efficient for heating small volume rooms. Space heaters generally provide two varieties of heat and utilize differing technologies to do so. Space heaters that provide radiative heat typically convert electrical current into heat through a resistance wire. The resistance wire increases in temperature, and the increase of temperature transfers to the surrounding environment. Convective heat space heaters employ the use of an impeller to expedite the heat transfer process.

U.S. Pat. No. 4,350,287 to Kennith E. Richards relates to a remote-control car heater. The described remote-control car heater includes a remote transmitter that is operative to start an electrical heater disposed in an automobile. The electrical heater operates off a separate electrical system from that normally found in the automobile. Once the automobile engine is started and the heating system of the automobile is operative, a thermostatic switch is actuated which removes power from the electrical heater.

### SUMMARY OF THE INVENTION

In view of the foregoing disadvantages inherent in the known space heater art, the present disclosure provides a novel remote-controlled automobile heater system and method. The general purpose of the present disclosure, which will be described subsequently in greater detail, is to provide an efficient and effective remote-controlled automobile heater system and method.

A remote-controlled automobile heater system and method is disclosed herein. The remote-controlled automobile heater system and method includes a housing having a top-side, a bottom-side and at least one face extending between a top-side and a bottom-side. The housing further comprises a housing-interior and a housing-exterior. The housing is suitably sized to fit in a cab of an automobile. The housing includes a magnet attached to the top-side of the housing-exterior. The magnet is of sufficient strength to magnetically retain the housing and all included contents to a surface. A heating element is located within the housing-interior and is configured to convert electrical energy into a radiative heat. A mechanical fan is configured to create a flow of air across the heating element, converting the radiative heat into convective heat. A controller that includes a thermostat for reading temperature, a rheostat for controlling temperature, and a radio receiver for remote controllability is in communication with the heating element and the mechanical fan. A power-source is located in the housing and configured to provide energy to the heating element and the mechanical fan. A transmitter is further included in the remote-controlled automobile heater system. The transmitter is configured to be in wireless communication with the radio receiver for controlling the heating element and the mechanical fan remotely.

According to another embodiment, a method of using a remote-controlled automobile heater system is also disclosed herein. The method includes providing a remote-controlled automobile heater system as described above, coupling the magnet to a surface of the automobile, and controlling the remote-controlled automobile heater system with the transmitter.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a remote-controlled automobile heater system and method, constructed and operative according to the teachings of the present disclosure.

FIG. 1 is an exploded view of the remote-controlled automobile heater system according to an embodiment of the disclosure.

FIG. 2 is a side perspective view of the remote-controlled automobile heater system of FIG. 1, according to an embodiment of the present disclosure.

FIG. 3 is a side perspective view of the remote-controlled automobile heater system of FIG. 1, according to an embodiment of the present disclosure.

FIG. 4 is a cutaway view of the remote-controlled automobile heater system of FIG. 1, according to an embodiment of the present disclosure.

FIG. 5 is a flow diagram illustrating a method for using a remote-controlled automobile heater system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a space heater and more particularly to a remote-controlled automobile heater system and method as used to improve the efficient heating of interiors of vehicles.

Generally, the remote-controlled automobile heater system is a device that a user may attach to the ceiling of the passenger compartment of their automobile with a magnet (or other suitable attaching means). The remote-controlled automobile heater may include a rechargeable power source and receive a signal via a remote control to start a heating element and a fan. Alternatively, the remote-controlled automobile heater system may draw power from the battery of the automobile when it is in both a running and not running state. The heating element and the fan will effectively pre-heat the passenger compartment of an automobile before a user enters.

The remote-controlled automobile heater system may embody virtually any suitable shape and any size to accommodate the particular aesthetic appeal of the user. In one embodiment, the remote-controlled automobile heater system may be rounded, in another flat, and in yet another, stackable and rigid. Colors, shapes, and specific designs of the system may be at the preference of the end-user. The remote-controlled automobile heater system includes a powerful magnet that is designed to attach the unit to a metal surface of the automobile. The remote-controlled automobile heater system may be kept in the passenger compartment of an automobile overnight waiting to be activated via a remote.

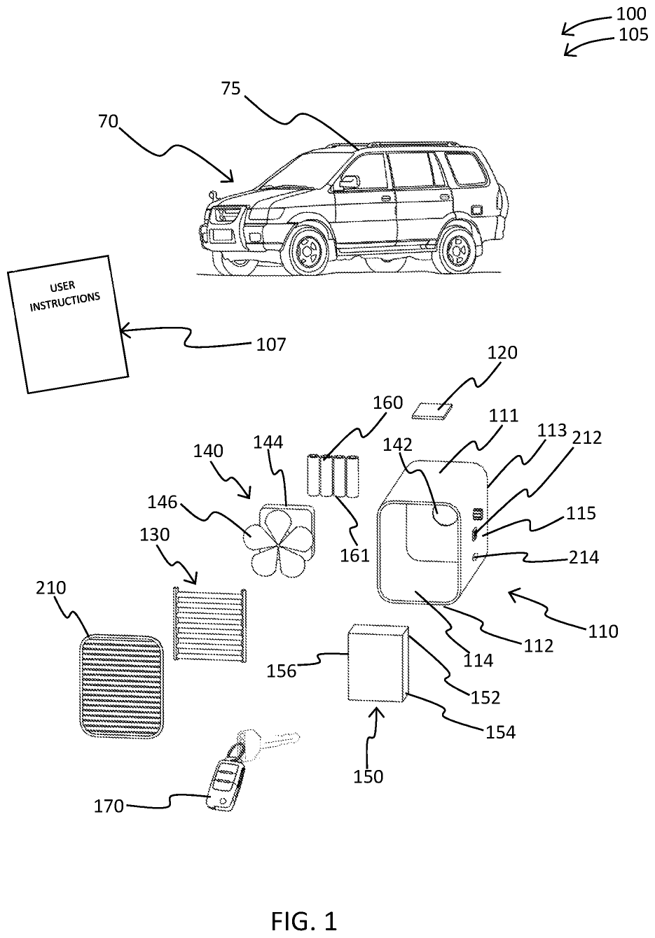

Referring now more specifically to the drawings by numerals of reference, there is shown in FIGS. 1-4, various views of a remote-controlled automobile heater system 100.

FIG. 1 shows a remote-controlled automobile heater system 100 according to an embodiment of the present disclosure. Here, the remote-controlled automobile heater system 100 may be beneficial for to heat the cab of an automobile 70 or the like. As illustrated, the system 100 may include a housing 110 having a top-side 111, a bottom-side 112 and at least one face 113 extending between the top-side 111 and the bottom-side 112. The housing 110 includes a housing-interior 114 and a housing-exterior 115. The housing 110 is sized to fit in a cab 75 of an automobile 70. A magnet 120 is also included; the magnet 120 disposed on the top-side 111 of the housing-exterior 115 of the housing, the magnet 120 configured to retain the housing 110 to a surface. A heating element 130 is also included, the heating element 130 is configured to convert electrical energy into radiative heat. The heating element 130 is disposed on the housing-interior 114. A mechanical fan 140 is included in the remote-controlled automobile heater system 100. The mechanical fan 140 includes an air inlet 142, a motor 144 and an impeller 146. The mechanical fan 140 is configured to create airflow and disperse radiative heat of the heating element 130 to create convective heat.

A controller 150 for the remote-controlled automobile heater system 100 is shown. The controller 150 includes a thermostat 152, a rheostat 154, and a radio-receiver 156. The controller 150 is located in the housing 110 and is in electrical communication with the mechanical fan 140 and the heating element 130. The controller 150 may be programmed to actuate the mechanical fan 140 and the heating element 130, as well as provide feedback during operation of the remote-controlled automobile heater system 100. A power-source 160 is configured to provide energy to the heating element 130 and to power the mechanical fan 140. The power-source 160 is preferably disposed within the housing 110 and in electrical communication with the controller 150, the heating element 130, and the mechanical fan 140. The power-source 160 may be a battery 161. A transmitter 170 is included and integral to operation with the remote-controlled automobile heater system 100. The transmitter 170 is exterior to the housing 110 and configured to be in wireless communication with the controller 150. The transmitter may be configured send a signal to the radio-receiver 156 and actuate the mechanical fan 140 and the heating element 130.

The remote-controlled automobile heater system 100 further may comprise a diffuser 210 configured to evenly distribute convective heat. The diffuser 210 may extend between the housing-interior 114 and the housing-exterior 115. The remote-controlled automobile heater system 100 further may comprise a digital display 212 disposed on the housing-exterior 115. The digital display 212 may be configured to show ambient temperature. The remote-controlled automobile heater system 100 may further comprise an indicator light 214 disposed on the housing-exterior 115. The indicator light 214 may be in communication with the controller 150 and illuminated when the heater is in a powered state.

According to one embodiment, the system 100 may be arranged as a kit 105. In particular, the system 100 may further include a set of instructions 107. The instructions 107 may detail functional relationships in relation to the structure of the system 100 such that the system 100 can be used, maintained, or the like, in a preferred manner.

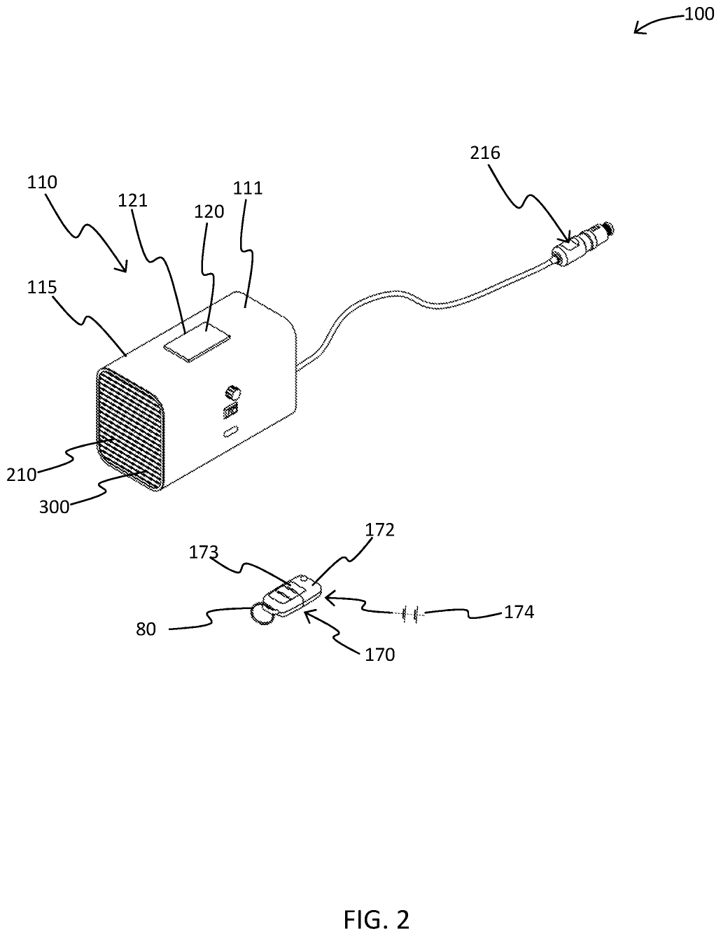

Referring now to FIG. 2 showing the remote-controlled automobile heater system 100 of FIG. 1, according to an embodiment of the present disclosure. As above, the remote-controlled automobile heater system 100 may include a housing 110 having a magnet 120 on the top-side 111 of the housing-exterior 115 (FIG. 1). The magnet 120 may be composed from a rare earth material 121 such as neodymium. Alternatively, the magnet 120 may be factory configured to magnetic specifications. The magnet 120 may be of sufficient strength to retain the housing 110 including the heating element 130 (FIG. 1), the mechanical fan 140 (FIG. 1), the controller 150 (FIG. 1) and the power-source 160 (FIG. 1) to the cab 75 (FIG. 1) of an automobile 70 (FIG. 1). The system further may comprise a diffuser 210 configured to evenly distribute convective heat. The diffuser 210 may be made of a heat conductive material 300 such as copper, aluminum, steel and alloys thereof. Alternatively, the diffuser 210 may be made from non-conductive material 300 such as plastics, ceramics and alloys thereof.

A transmitter 170 is configured to be in communication with the radio-receiver 156 (FIG. 1) that is integral to the controller 150 (FIG. 1) of the remote-controlled automobile heater system 100. The transmitter 170 may be housed within a transmitter-housing 172 having a button 173. The button 173 on the transmitter-housing 172 may be used to signal the radio-receiver 156 and activate the mechanical fan 140 (FIG. 1) and the heating element 130 (FIG. 1). The transmitter-housing 172 may be configured to fit on a keyring 80 for ease of portability. The transmitter-housing 172 may further include a transmitter-battery 174 to be in electrical communication with the transmitter 170 for powering communication with the radio-receiver 156.

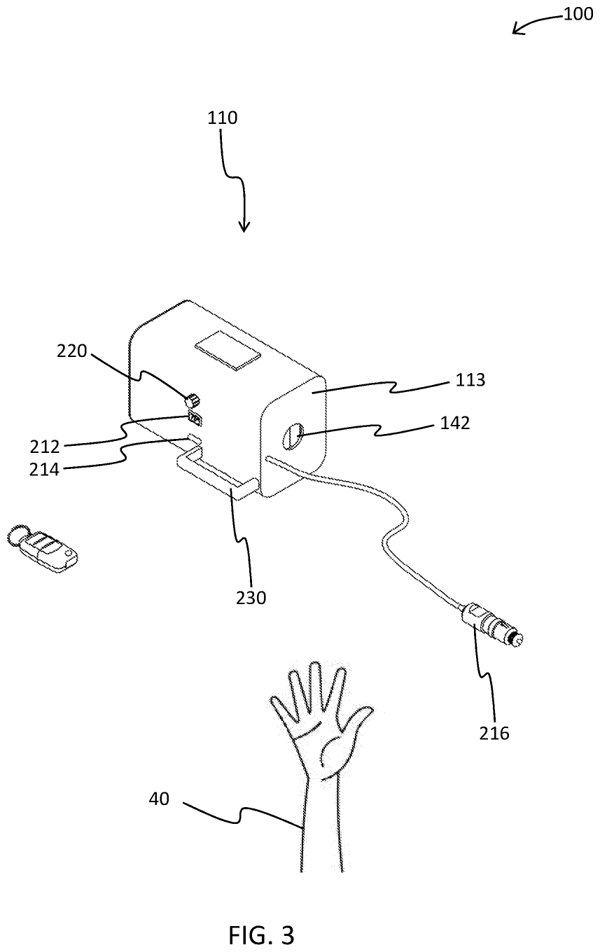

FIG. 3 is a rear perspective view of the remote-controlled automobile heater system 100 of FIG. 1, according to an embodiment of the present disclosure. As shown, the housing 110 may include an air inlet 142 disposed on the at least one face 113 of the housing 110. The air inlet 142 may define a conduit between the housing-exterior 115 (FIG. 1) and the housing-interior 114 (FIG. 1). The air inlet 142 may allow the mechanical fan 140 (FIG. 1) to create airflow past the heating element 130 (FIG. 1) and out the diffuser 210 (FIG. 2). The controller 150 (FIG. 1) may further include a DC to AC inverter 216. The DC to AC inverter 216 may allow for the remote-controlled automobile heater system 100 to utilize energy from the power-source 160 (FIG. 1) more efficiently. The remote-controlled automobile heater system 100 may draw power from the automobile 70 (FIG. 1). The power-source 160 may be a battery 161 (FIG. 1). The battery 161 may be internal to the remote-controlled automobile heater system 100 and be located within the housing 110.

The housing-exterior 115 of the remote-controlled automobile heater system 100 may include a knob 220. The knob 220 may be attached to and configured to control the rheostat 154 (FIG. 1). The knob 220 may be turned to control current that passes through the rheostat 154 to the heating element 130. The knob 220 may serve to control relative speed of the mechanical fan 140 (FIG. 1). Further functionalities of the knob 220 and similar control mechanisms integrated with the remote-controlled automobile heater system 100 are also considered. A digital display 212 may be disposed on the housing-exterior 115 that may be configured to show the ambient temperature. The digital display 212 may further show other information such as heating element 130 temperature, energy expenditure, mechanical fan 140 speed and other conceived data. An indicator light 214 may be disposed on the housing-exterior 115. The indicator light 214 may be in communication with the controller 150 (FIG. 1) and illuminate when the remote-controlled automobile heater system 100 is active. The housing 110 may further include a non-conductive handle 230 configured to be gripped by a user 40. The non-conductive handle 230 may not absorb or retain heat from operation of the remote-controlled automobile heater system 100.

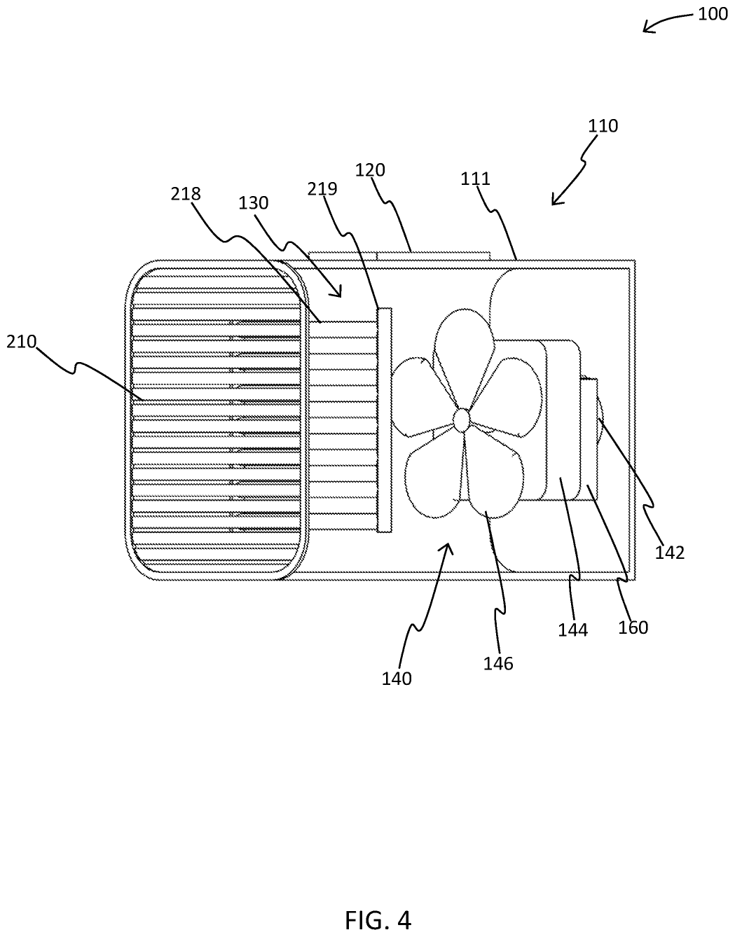

Referring now to FIG. 4 showing a cutaway view of the remote-controlled automobile heater system 100 of FIG. 1, according to an embodiment of the present disclosure. As shown, the present invention comprises a housing 110 having a magnet 120 attached to the top-side 111. In an alternate embodiment, the magnet 120 may be removable and replaceable from the housing-exterior 115 (FIG. 1). Removability of the magnet 120 may allow for the storage of the remote-controlled automobile heater system 100 without risking magnetic attraction to other ferromagnetic materials. The magnet 120 may further be replaced with a magnet 120 of varying strengths and sizes corresponding to necessity. Other securing means may be used.

Further shown is an orientation of the mechanical fan 140 and the heating element 130 within the housing 110 of the remote-controlled automobile heater system 100. The mechanical fan 140 includes an impeller 146, a motor 144 to rotate the impeller 146, and a power-source 160 to power the motor 144. In a preferred embodiment, the mechanical fan 140 will draw airflow through the air inlet 142, past the heating element 130, and out the diffuser 210. The heating element 130 may comprise of a plurality of nichrome wires 218 supported by a ceramic insulator 219. The plurality of nichrome wires 218 may be replaced with similar resistance wires including kanthal resistance wires comprising ferritic iron and chromium-alloy metals, stainless steel wires, and further conceived resistance wires for the purpose of emitting heat when powered.

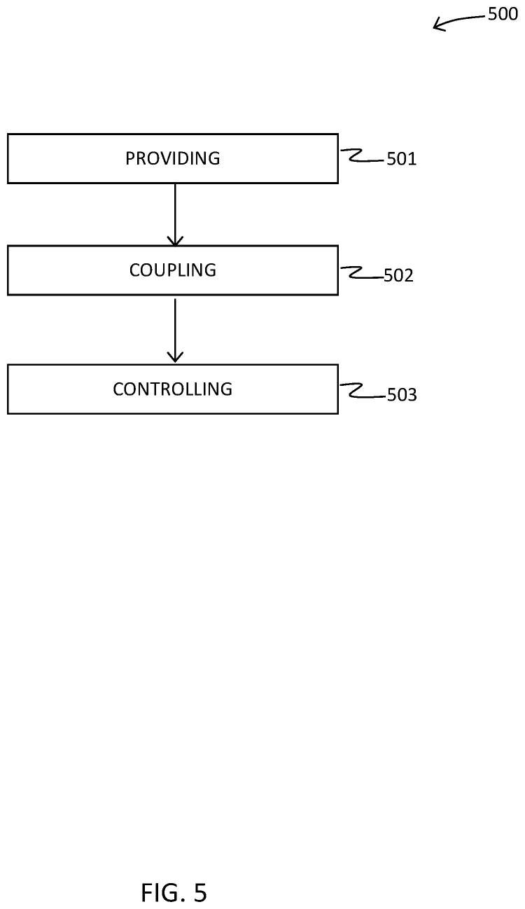

FIG. 5 is a flow diagram illustrating a method for using 500 a remote-controlled automobile heater system 100, according to an embodiment of the present disclosure. In particular, the method for using 500 a remote-controlled automobile heater system 100 may include one or more components or features of the remote-controlled automobile heater system 100 as described above. As illustrated, the method for using 500 a remote-controlled automobile heater system 100 may include the steps of: step one 501, providing a remote-controlled automobile heater system, the remote-controlled automobile heater system comprising: a housing, the housing having a top-side, a bottom-side and at least one face extending between the top-side and the bottom-side, a housing-interior and a housing-exterior, the housing sized to fit in a cab of an automobile; a magnet, the magnet disposed on the top-side of the housing-exterior of the housing, the magnet configured to retain the housing to a surface; a heating element, the heating element configured to convert electrical energy into radiative heat, the heating element disposed on the housing-interior; a mechanical fan, the mechanical fan including an air inlet, a motor and an impeller, the mechanical fan configured to create airflow and disperse the radiative heat of the heating element and create convective heat; a controller, the controller including a thermostat, a rheostat, and a radio receiver the controller located in the housing and in electrical communication with the mechanical fan and the heating element; a power-source, the power-source configured to provide energy to the heating element and to power the mechanical fan, the power-source disposed within the housing and in electrical communication with the controller, the heating element and the mechanical fan; a transmitter, the transmitter exterior to the housing and configured to be in wireless communication with the controller; step two 502, coupling the magnet to the cab of an automobile; step three 503, controlling the remote-controlled automobile heater system with the transmitter.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using a remote-controlled automobile heater system are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A remote-controlled automobile heater system for an automobile, the system comprising:
a housing, the housing having a top-side, a bottom-side and at least one face extending between the top-side and the bottom-side, a housing-interior and a housing-exterior, the housing sized to fit in a cab of an automobile;
a magnet, the magnet disposed on the top-side of the housing-exterior of the housing, the magnet configured to retain the housing to a surface;
a heating element, the heating element configured to convert electrical energy into radiative heat, the heating element disposed on the housing-interior;
a mechanical fan, the mechanical fan including an air inlet, a motor and an impeller, the mechanical fan configured to create airflow and disperse the radiative heat of the heating element and create convective heat;
a controller, the controller including a thermostat, a rheostat, and a radio receiver the controller located in the housing and in electrical communication with the mechanical fan and the heating element;
a power-source, the power-source configured to provide energy to the heating element and to power the mechanical fan, the power-source disposed within the housing and in electrical communication with the controller, the heating element and the mechanical fan;
a transmitter, the transmitter exterior to the housing and configured to be in wireless communication with the controller; and
wherein the remote-controlled automobile heater system is configured to provide heat to the cab of an automobile.

2. The system of claim 1, further comprising a diffuser configured to evenly distribute convective heat, the diffuser extending between the housing-interior and the housing-exterior.

3. The system of claim 1, further comprising a digital display disposed on the housing-exterior, the digital display configured to show ambient temperature.

4. The system of claim 1, further comprising an indicator light disposed on the housing-exterior, the indicator light in communication with the controller and illuminate when the remote-controlled automobile heater system is active.

5. The system of claim 2, wherein the diffuser is made of a heat conductive material.

6. The system of claim 1, wherein the magnet is composed from a rare earth material.

7. The system of claim 1, wherein the controller further includes a DC to AC inverter.

8. The system of claim 1, wherein the heating element comprises a plurality of nichrome wires supported by a ceramic insulator.

9. The system of claim 1, wherein the air inlet is disposed on the at least one face of the housing, the air inlet defines a conduit between the housing-exterior and the housing-interior.

10. The system of claim 1, wherein the rheostat is connected to a knob disposed on the housing-exterior.

11. The system of claim 1, wherein the system is configured to draw power from the automobile.

12. The system of claim 1, wherein the power-source is a battery.

13. The system of claim 1, wherein the magnet is removable and replaceable from the housing-exterior.

14. The system of claim 1, wherein the transmitter is housed within a transmitter-housing having a button, the transmitter-housing configured to fit on a keyring.

15. The system of claim 14, wherein the transmitter-housing further includes a transmitter-battery configured to power the transmitter.

16. The system of claim 1, wherein the housing further includes a non-conductive handle configured to be gripped by a user.

17. A system, the system comprising:
a housing, the housing having a top-side, a bottom-side and at least one face extending between the top-side and the bottom-side, a housing-interior and a housing-exterior, the housing sized to fit in a cab of an automobile,
a magnet, the magnet disposed on the top-side of the housing-exterior of the housing, the magnet configured to retain the housing to a surface,
a heating element, the heating element configured to convert electrical energy into radiative heat, the heating element disposed on the housing-interior,
a mechanical fan, the mechanical fan including an air inlet, a motor and an impeller, the mechanical fan configured to create airflow and disperse the radiative heat of the heating element and create convective heat,
a controller, the controller including a thermostat, a rheostat, and a radio receiver the controller located in the housing and in electrical communication with the mechanical fan and the heating element,
a power-source, the power-source configured to provide energy to the heating element and to power the mechanical fan, the power-source disposed within the housing and in electrical communication with the controller, the heating element and the mechanical fan,
a transmitter, the transmitter exterior to the housing and configured to be in wireless communication with the controller, and
wherein the remote-controlled automobile heater system is configured to provide heat to the cab of an automobile;
further comprising a diffuser configured to evenly distribute convective heat, the diffuser extending between the housing-interior and the housing-exterior;
further comprising a digital display disposed on the housing-exterior, the digital display configured to show ambient temperature;
further comprising an indicator light disposed on the housing-exterior, the indicator light in communication with the controller and illuminate when the remote-controlled automobile heater system is active;
wherein the diffuser is made of a heat conductive material;
wherein the magnet is composed from a rare earth material;
wherein the controller further includes a DC to AC inverter;
wherein the heating element comprises a plurality of nichrome wires supported by a ceramic insulator;
wherein the air inlet is disposed on the at least one face of the housing, the air inlet defines a conduit between the housing-exterior and the housing-interior;
wherein the rheostat is connected to a knob disposed on the housing-exterior;
wherein the system is configured to draw power from the automobile;
wherein the power-source is a battery;
wherein the magnet is removable and replaceable from the housing-exterior;
wherein the transmitter is housed within a transmitter-housing having a button, the transmitter-housing configured to fit on a keyring;
wherein the transmitter-housing further includes a transmitter-battery configured to power the transmitter;
wherein the housing further includes a non-conductive handle configured to be gripped by a user;

18. The system of claim 17, further comprising set of instructions; and
wherein the system is arranged as a kit.

19. A method of using a remote-controlled heater device, the method comprising the steps of:
providing a remote-controlled automobile heater system, the remote-controlled automobile heater system comprising: a housing, the housing having a top-side, a bottom-side and at least one face extending between the top-side and the bottom-side, a housing-interior and a housing-exterior, the housing sized to fit in a cab of an automobile; a magnet, the magnet disposed on the top-side of the housing-exterior of the housing, the magnet configured to retain the housing to a surface; a heating element, the heating element configured to convert electrical energy into radiative heat, the heating element disposed on the housing-interior; a mechanical fan, the mechanical fan including an air inlet, a motor and an impeller, the mechanical fan configured to create airflow and disperse the radiative heat of the heating element and create convective heat; a controller, the controller including a thermostat, a rheostat, and a radio receiver the controller located in the housing and in electrical communication with the mechanical fan and the heating element; a power-source, the power-source configured to provide energy to the heating element and to power the mechanical fan, the power-source disposed within the housing and in electrical communication with the controller, the heating element and the mechanical fan; a transmitter, the transmitter exterior to the housing and configured to be in wireless communication with the controller;
coupling the magnet to the cab of an automobile; and
controlling the remote-controlled automobile heater system with the transmitter;
